(19) United States
(12) Patent Application Publication
(10) Pub. No.: US 2017/0214645 A1
(43) Pub. Date: Jul. 27, 2017

(54) DYNAMIC MESSAGING SYSTEM

(71) Applicant: WELLPASS, INC., Arlington, VA (US)

(72) Inventors: Stan Berkow, New York, NY (US); Paul Biancaniello, Philadelphia, PA (US); Brad Hammonds, New York, NY (US)

(21) Appl. No.: 15/412,371

(22) Filed: Jan. 23, 2017

Related U.S. Application Data
(60) Provisional application No. 62/281,286, filed on Jan. 21, 2016.

(51) Int. Cl. H04L 12/58

(52) U.S. Cl. CPC H04L 51/18; H04L 67/306

(57) ABSTRACT

A dynamic messaging system may include a question-response engine embodied as machine-executable instructions. A user employs the engine to create, modify, and store questions, statements, and responses to be used in communicating with a second party. Thus, one user can use the engine to send a customizable communication to at least second user. The second user can then respond and based on the response a second communication from the first user can be created automatically based on the content of the response.

### CLAIM OF PRIORITY

This application claims the priority of U.S. Ser. No. 62/281,286 filed on Jan. 21, 2016, the contents of which are fully incorporated herein by reference.

### FIELD OF THE EMBODIMENTS

The field of the embodiments of the present invention relate to a dynamic messaging system that utilizes the dynamic creation and altering of messages within a messaging protocol to customize the messages and provide analytics regarding user feedback.

### BACKGROUND OF THE EMBODIMENTS

Most all in today's society are actively involved in sending and receiving information using a variety of messaging formats, systems, and message sending/receiving devices. For example, an individual might, in a single day, send or respond to numerous electronic mails (e-mail), text messages, phone calls, and the like. Often these messages will vary in their level of importance depending on the originator of the messages and the content contained therein. In some group messaging contexts, the post-message processing, organizing, and reporting of multiple message responses can be important in further decision making by the message originator.

In turn, many individuals may not have time to physically respond to every message or may need a reminder about a particular event or action that is to occur. For example, many doctors do not have the time to discuss with a patient their care and progress once they leave the hospital, clinic, etc. Further, many patients may forget or choose not to partake in any assigned at home therapy, behavioral modifications, etc. that may cause them to become a repeat patient in a hospital, clinic, etc. By opening up these channels of communication, and providing some automation to the system one cannot only track a patient's progress but also keep an open line of communication with the patient to help them from reenrolling in inpatient services saving time and money for the patient.

Also, known systems do not necessarily permit the message notification methods to be defined by the recipients. Accordingly, systems using such methods are deficient in responding to these requirement. Thus, there is a need for a system and method that provides for dynamic messaging and interaction between remotely located individuals. Such a system is preferably capable of utilizing responses to create a dynamic, automatically generated conversation based on the individual's characteristics and the content contained in the exchanged messages. The present invention and its embodiments meet and exceed these objectives.

### Review of Related Technology

U.S. Pat. No. 7,685,245 pertains to a digital notification and response system utilizing an administrator interface to transmit a message from an administrator to a user contact device. The system comprises a dynamic information database that includes user contact data, priority information, and response data. The administrator initiates distribution of the message based upon grouping information, priority information, and the priority order. The message is transmitted through at least two industry standard gateways simultaneously to groups of user contact devices based upon priority information. Once the message is received by the user contact device, the user contact device transmits a response through the industry standard gateways back to the dynamic information database.

U.S. Patent Application 2015/0051951 pertains to a system that includes a question repository to store multiple sets of questions, each set of questions including questions that may have a superficial, semantic, or open-ended modifier portion. A survey management module can allow a user to select a set of questions from the question repository for an online survey. A benchmarking module can group questions by semantic modifier options and provide an analysis based on information about the survey-creator and other survey-creators.

Various systems and methodologies are known in the art. However, their structure and means of operation are substantially different from the present disclosure. The other inventions fail to solve all the problems taught by the present disclosure. The present invention provides for a seamless and fully automated messaging system that send fully customizable messages and responses to remotely located parties. At least one embodiment of this invention is presented in the drawings below and will be described in more detail herein.

### SUMMARY OF THE EMBODIMENTS

In general, the present invention and its embodiments provide a digital dynamic messaging system that is capable of being utilized by two remote parties to communicate more effectively and expeditiously without necessitating constant manual oversight. The messaging system may be used by two individuals or may be used by more than two individuals. The messaging system may also permit for group messaging such as when one individual sends or causes to send a message to numerous individuals. Overall, the present invention and its embodiments, lead the way for a dynamic messaging system and method that enables personalized messages to be received by each user as the conversation unfolds in an automated or semi-automated fashion.

Such functionality may be achieved by the question-response engine which is capable of sending a customizable message to one or more individuals. The message may be pre-configured by a message sender and, in some instances, saved in a repository, database, or bank. The message(s) are preferably fully fluid or dynamic messages but may also include both static and dynamic portions. In such instances, the static portions remain unchanged for each recipient, but the dynamic portions are tailored to each of the recipients based on a variety of factors. For example, the dynamic portions may be completed with information from an electronic medical record or other profile of the recipient.

Once a user responds to the customized message, a reply may be automatically sent using the information contained in the response from the user. For example, if the original message asked if one had worked out that day and the user replied no, then the originator could automatically send a reminder to work out along with any specific exercises or variables to be met based upon their particular condition, ailment, injury, or the like.

In some embodiments, a tag or identifier may be applied to the messages. This identifier may allow for tracking of the messages, filtering of messages, nature of responses according to identifier, and other metrics. This tagging may further be used in various analytics to determine the nature future communications, improve recommendations, increase responses, and the like or some combination thereof.

In one embodiment of the present invention there is a dynamic messaging system having a question-response engine comprising machine-executable instructions stored on a memory and communicatively coupled to at least one processor, the question response engine, when executed, being configured to send at least one first customizable communication to at least one user, and the question-response engine being further configured to receive at least one response from the at least one user and send at least one second customizable communication based on information contained in the at least one response.

In another embodiment of the present invention there is a computer implemented method embodied in a non-transitory computer-readable medium comprising computer readable instructions, which when executed by a processor, cause the processor to perform a method of dynamic messaging between at least a first location and a second location, the method having the steps of: a first user configuring a question-response engine to contain at least one customizable question and at least one customizable response; storing the at least one customizable question and the at least one customizable response in a question-response repository; a first user sending at least one first customizable communication to at least one second user, wherein the communication is a question, response, or statement or a combination thereof; the second user sending at least one response to the first user; sending, from the first user, at least one second customizable communication based on information contained in the at least one response.

In yet another embodiment of the present invention there is a computer implemented method embodied in a non-transitory computer-readable medium comprising computer readable instructions, which when executed by a processor, cause the processor to perform a method of dynamic messaging between at least a first location and a second location, the method comprising the steps of: a first user configuring a question-response engine to contain at least one customizable question and at least one customizable response; storing the at least one customizable question and the at least one customizable response in a question-response repository; collecting information pertaining to the at least one second user before sending the at least one customizable communication; a first user sending at least one first customizable communication to at least one second user, wherein the communication is a question, response, or statement or a combination thereof and wherein the at least one first communication is tagged with an identifier; the second user sending at least one response to the first user; and automatically sending, from the first user, at least one second customizable communication from the question-response engine based on information contained in the at least one response.

In general, the present invention succeeds in conferring the following, and others not mentioned, benefits and objectives.

It is an object of the present invention to provide a system that facilitates doctor/patient interactions.

It is an object of the present invention to provide a system that creates a dynamic conversation between remote parties.

It is an object of the present invention to provide a system allows communications to be analyzed and monitored.

It is an object of the present invention to provide a system that uses patient data to create dynamic correspondences to be used with the patient.

It is an object of the present invention to provide a system allows a patient to control the nature of the communications received.

It is an object of the present invention to provide a system that is HIPAA compliant.

It is an object of the present invention to provide a system increases the level of care provided to an individual from a health services provider.

It is an object of the present invention to provide a system that allows for health recommendations to be made remotely and in real time.

### BRIEF DESCRIPTION OF THE DRAWINGS

FIG. 1 is a high level overview of a system architecture of an embodiment of the present invention.

FIG. 2 is an example screen illustrating a customizable conversation screen.

FIG. 3 is an example screen illustrating a client profile screen.

FIG. 4 is an example screen illustrating filtering functionality associated with an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations.

One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.”

Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s))” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O.

In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like.

The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like.

Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state.

The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx.

Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the cooling chest system, including temperature sensors, ice dispensers (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, ice maker, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation.

In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T′s UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. The operating system may be one specifically optimized to be run on a mobile computing device, such as iOS, Android, Windows Phone, Tizen, Symbian, and/or the like.

An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components.

After a Domain Name System (DNS) resolution portion of an HTTP request is resolved to a particular information server, the information server resolves requests for information at specified locations on the controller of the present invention based on the remainder of the HTTP request. For example, a request such as “http://123.124.125.126/myInformation.html” might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like.

The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network.

The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Preferred Embodiment

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

Embodiments of the Present Invention

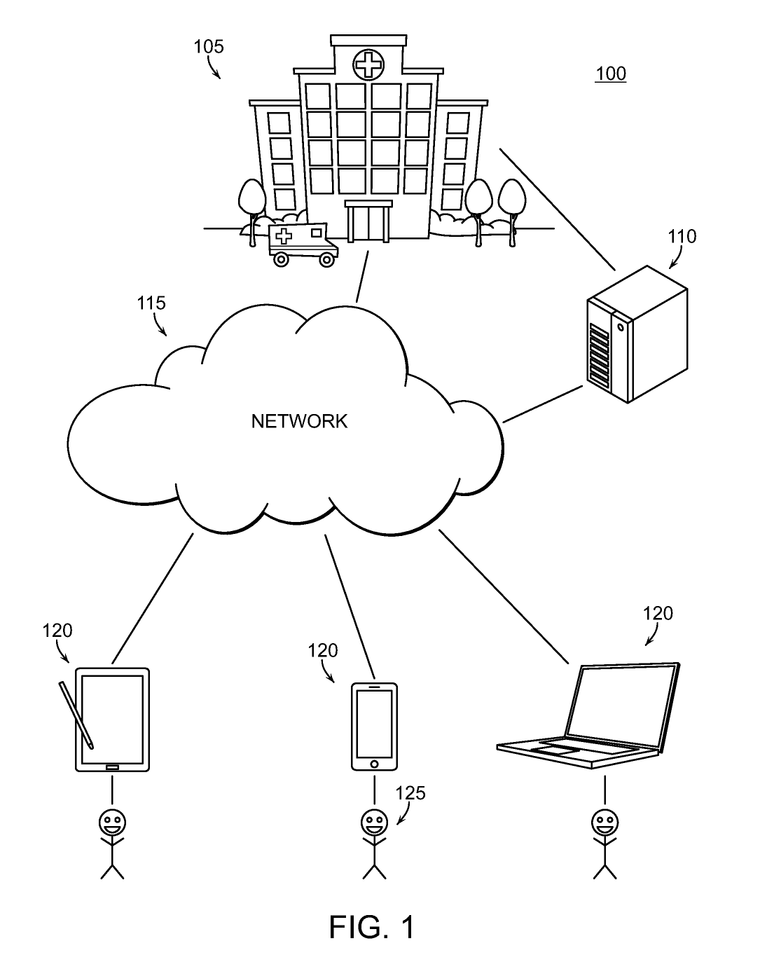

Referring now to FIG. 1, there is a high level overview of an embodiment of the present invention. The system 100 generally comprises at least a services provider 105, a storage server 110, a network 115, at least one electronic device 120, and at least one end user 125. The system 100, as a whole, may generally serve to function as a platform to deliver tailored content, in some embodiments, health support to the end users 125 or patients before, during, and in between doctor, hospital, clinic visits and the like. The communications may be completed or achieved electronically over text messages, SMS, electronic mail, IVR, VOIP, and the like or some combination thereof. The communications, in one embodiment, are intended to be a blend of automated and customizable messages to serve as reminders for the end users 125 as well as facilitate tailored conversations to the end users 125 to assess their health and progress.

Thus, a doctor, nurse, physician, etc. located at a services provider 105, such as a clinic or hospital, may generate an electronic message to be sent to one or more end users 125 or patients. The electronic message may be delivered over a communications network 115 such as the internet. In some embodiments, the electronic message is further stored in a server 110 for later recall and usage in accordance with the present invention. The electronic message can then be delivered to the electronic device 120 of the end user 125. In order to receive certain communications, an end user 125 may have to consent to such communications in order to comply with the telephone consumer protection act (TCPA) guidelines or with the health insurance portability and accountability act (HIPAA) or with various other governmental regulations, privacy protocols, permission protocols, and the like or some combination thereof. Failure by the end user 125 or patient to provide the requisite consent or permission may limit in some respect the nature of communications capable of being received by the end user 125 from the service provider 105. Assuming the above requirements are met, the end user 125 can now freely send and receive electronic communications from a service provider 105 such as their medical services provider.

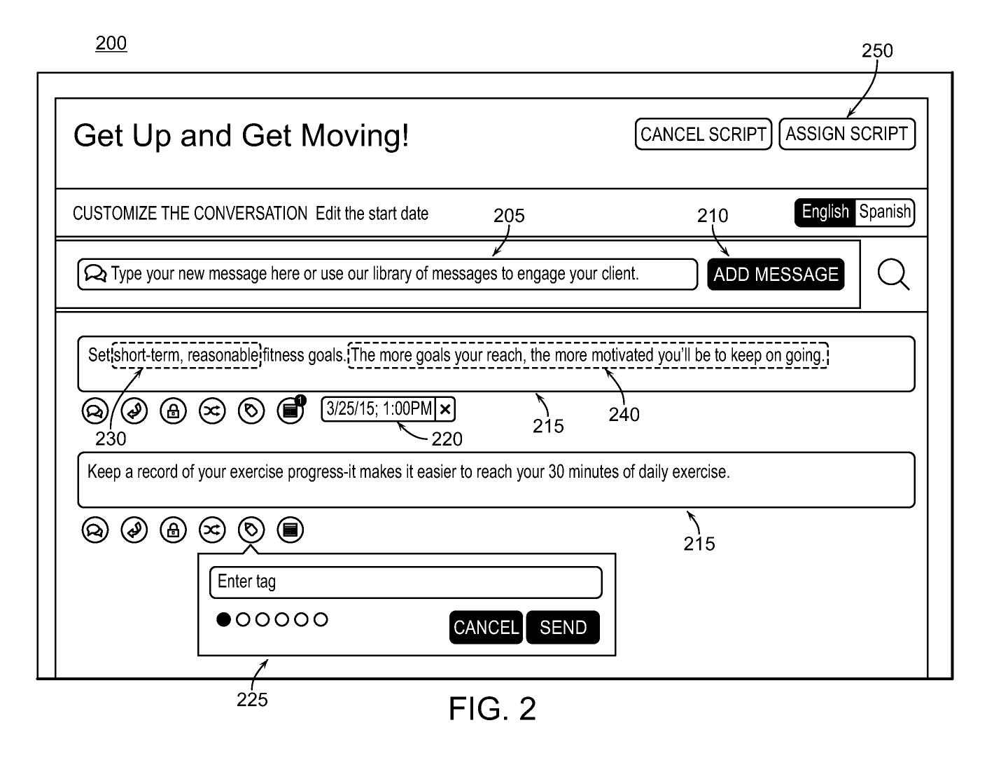

FIGS. 2-4 illustrate example screens from a user interface by which a services provider, end user (patient), or the like may utilize to communicate with one another in accordance with the embodiments described herein. These screens are shown for exemplary purposes only and the actual implementation of the screens in the user interface may differ from what is shown herein. These screens facilitate the communication between the service provider(s) and end user(s) and each end of the communication spectrum may see the same or a different screen with differing options tailored to their particular class of usage.

Referring now to FIG. 2, there is an interface 200 where one, such as a service provider, may manipulate the communications to be sent in order to properly tailor the communications to the recipient(s). Such an interface 200 may be the main user interface that facilitates the communications between the services provider and the end user. In order to facilitate this communication, the user interface may have a number of features that may be utilized singularly or in conjunction with other features.

For example, the interface 200 may have message bar 205 where a user may input their own message or select a message from the stored messages in the system message database. In some instances, one may be able to browse via keywords, categories, content, etc. to find the appropriate message(s) to be sent to the remote party. Generally, one may be able to create a fully customizable or unique message which allows for tailored communications to occur between the parties. In other embodiments, a user may be able to create their own message and designate parts of the message as static and dynamic. Any of the user created messages may be able to be saved by using an “add message” button 210. This will store the message either locally or in some embodiments on a remote server or other database.

When creating a message, a user may be able to input virtually any string of characters to complete a portion or all of a message or correspondence. This enables a fully tailored communication to be sent and received by the end user. By creating and saving a number of unique messages, a dialogue can be created between, for example, a doctor and patient. In one scenario, a doctor has created a number of messages, some of which may be linked to one another in some respect, whether it be via a user defined hierarchy (message tree), system algorithms, or the like, which enables seamless communication to occur once the initial message has been sent. Thus, a secondary communication may generated based on the content of the response received from the end user and automatically sent back to the end user. This may continue until no response is received or until a “stop” message has been sent which notifies the system that the message/communication string is complete and no further message is required to be sent to the end user.

In other embodiments, various parts of the message may be highlighted and designated as “static” or “dynamic” or some other descriptor based on intended usage and content. Such a message can utilized, saved, and/or some combination thereof to complete a longer string of correspondences as described above. For example, the newly created message may be linked, in some respect, to any number of other messages. Thus, when the user receives a particular message from a patient, the message may be analyzed for certain syntax, tags, content, organization, etc. and the saved message may enable an automatic and tailored response to be created.

Further, as shown in customization bars 215, a user may select either a static message, a dynamic message, or a message having both static and dynamic components. It is preferable that the message is fully dynamic or customizable, but any other combination of message types may be contained under the purview of the present invention. In one of the customization bar 215, the message shown has a dynamic portion 230 and a static portion 240. Other parts of the message not explicitly designated as dynamic or static may be either or a combination thereof. In other instances, as shown in bottom customization bar 215, no designation is made and the message therein may be fully customizable.

In embodiments containing messages having both dynamic and static portions, the dynamic portion 230 may appear in a highlighted box or appear in a different color or have some other visual indicator to alert a user to the presence of this message component. The dynamic portion 230 may be readily changed with respect to the recipient of the message. For example, if a cardiologist desires to send a message in mass to multiple recipients, such as his patients, the dynamic portion 230 can be tailored to each of their needs. This may be achieved using information from a patient profile such as an electronic medical record (EMR).

For example, a doctor may send a general message to all of his patients. However, not every patient needs to receive the same message because each has its own recommended care, attributes, and the like. Thus, the message contains these “dynamic” portions 230 that can be readily manipulated, before sending, by the system. As noted above, this may be achieved by linking a patient's EMR with the system enabling information from the EMR to be integrated into the message thereby enabling the doctor to send one message that is tailored to virtually all of his patients. A message such as “it's been a couple days since your ______ surgery, how are you feeling?” can be modified to reflect the correct body portion or area. For example, while one person may receive a message stating “your knee surgery” another may receive a message stating “your ankle surgery.” The exact form and possibilities are endless.

In turn, based on the content of the reply message, a new message may be generated such as “great, keep making progress and I′ll see you soon” or “that doesn't sound too good, my assistant will call you to schedule an appointment.” Thus, a full conversation can be had and appointments can be scheduled virtually automatically based on one initial message sent by the doctor. This frees up both time and resources while providing an enhanced level of patient care.

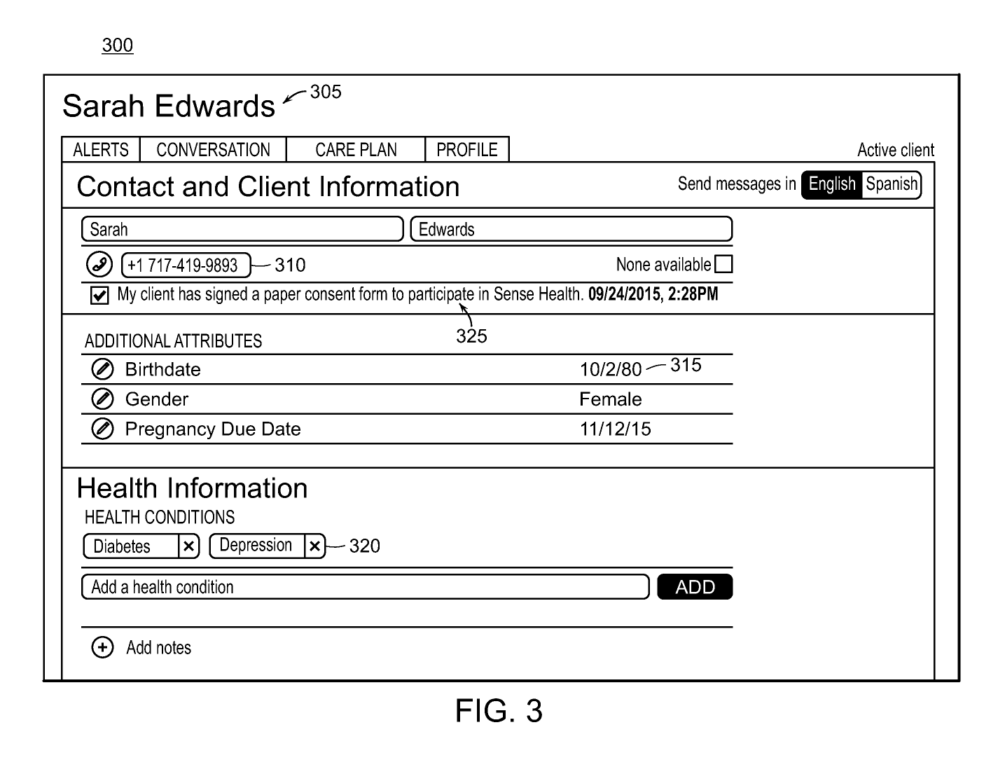

In FIG. 3, there is an exemplary patient or end user profile 300 that contains information as it relates to a particular person or persons. The profile is stored within the system in some respect in order to facilitate use of the system as a whole and enable the creation of fully tailored messages to be sent to dissimilar individuals. Some information to be included in such a patient profile 300 may be a personal identifier 305, contact information 310, participation information 325, personal information 315, and medical/health information 320.

The personal identifier 305 may include a name or names of a patient. The contact information 310 may include a mailing address, city, state, email address, phone number, social media handle, or other suitable contact details. The participation information 325 identifies the level and type of participation in the present system and may further allow for identifying which information may be used and the manner in which it may be used by the present system. The personal information 315 may include general attributes of a person such as age, birthday, gender, eye color, hair color, weight, marital status, and the like. The medical information 320 may include information related to one's various medical conditions, treatments, examinations, recommendations, prescriptions, labs, and the like or some combination thereof.

This information, along with other existing information, may be used in communicating with the patient, arranging appointments, and other varying uses in the present system. Such a patient profile 300, as shown, may be an electronic medical record, a user or patient generated record, a social media profile, a questionnaire, etc. or any combination thereof. Thus, when the initial message is created, as described above, the system may, before sending the message, check the patient profile 300 and mine information from the profile to complete the correspondence. Thus, there is a system link between the message interface, the created communication, and the patient profile that enables each communication to be dynamic with respect to the particular recipient of the message. Automatic responses generated from the initiator (e.g. doctor) may further utilize this information from the profile in generating responses.

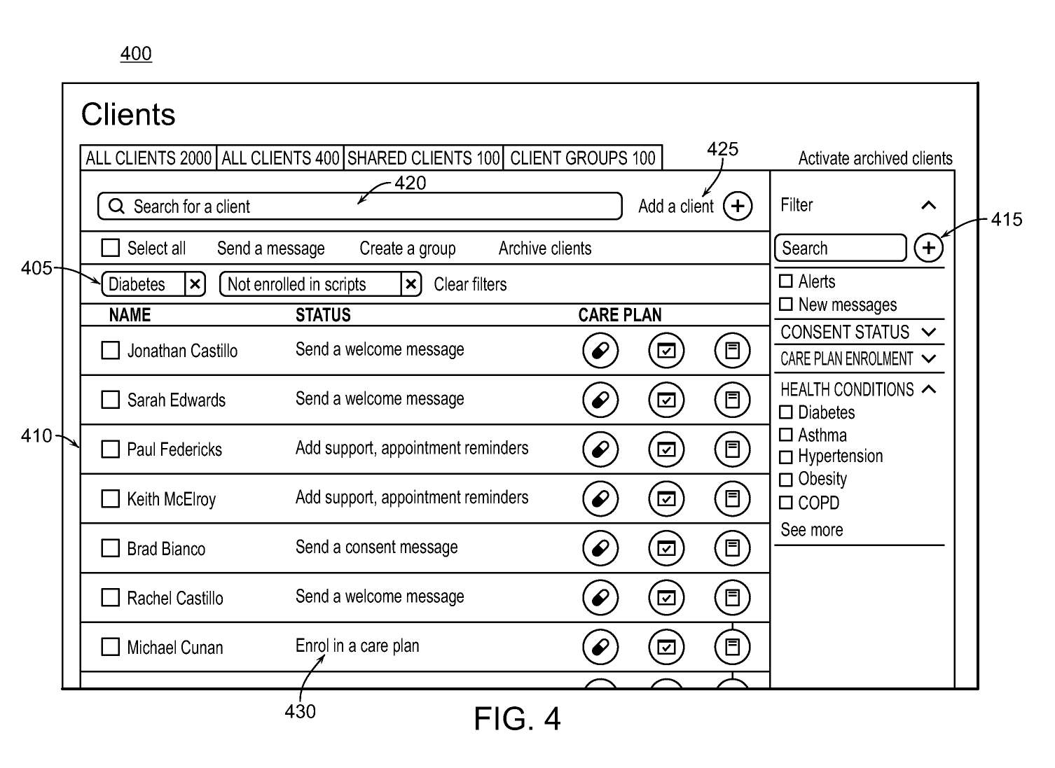

Referring now to FIG. 4, there is an example of a management screen 400 demonstrating the tagging and filtering ability associated with the system of the present invention. This screen is preferably only available to the medical service providers and may require administrative credentials in order to access such information. The screen 400 may contain at least filters 405, patient listings 410, filtering tools 415, search mechanism 420, add button 425, and a client/patient status 430 or some combination thereof.

In practice, a doctor, for example, may use the management screen 400 to find a particular patient or patients stored either locally or in a remote database or server. Using the search mechanism/function 420, a doctor may enter keyword(s) such as a portion or all of a patient's first name, last name, etc. to retrieve the necessary desired patient information or attributes. Virtually any other keyword(s) may also be used for search purposes and such keywords may be related to a particular affliction or some other specific physical attribute of a patient or patients. In some instances, a doctor must first use the add button 425 to add a patient and their profile to the system before the patient is searchable in the database. This enables a doctor to add information to a patient profile such as that shown in FIG. 3. In other instances, a doctor may use a similar functionality to edit or update a patient profile. In yet other embodiments, the system automatically updates the patient profile from an EMR or other patient file or record.

At times, searching by keyword or phrase may not be practical for a given desired search result. This may hold particularly true when the search returns many more results than desired or digestible by the doctor in order to retrieve the information necessary. Thus, the doctor or other provider may use the filtering tools 415 to apply filters 405 to the database of patients. The filtering tools 415 may comprise selectable variables that can be identified by the system in order to narrow or properly define the patient listing 410. Such variables may include but are not limited to their health prognosis, diagnosis, affliction, medication, treatment, consent status, health care insurance information, physical attributes, appointment date, attending physician, and the like or some combination thereof.

Once one of the filtering tools 415 is selected, it appears as a filter 405 and “removes” those from the database who do not conform or have that quality present in their profile. A filter 405 can be removed by ending a session or by clicking, for example, an “x” on the filter 405 thereby removing it from consideration. The filters 405 may be created at any time, but and may be created by the tags as shown in FIG. 2. By tagging a particular message or patient with a tag, this enables certain messages, patients, and the like to be tracked, monitored, and analyzed for communication and completeness purposes. The tags then enable a filter to be applied corresponding to some quality of that particular tag.

Each patient listing 410 has a number of attributes and the identifiers such as name, status, and care plan (all shown) may be capable of being modified to fit one's needs and desires. The status 430 may identify the most recent status taken by the system or for actions to be taken by the system of those in charge of making the decisions. Other descriptors or identifiers such as date, physical attributes, attending physician, and the like may be selectively shown in the screen.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A dynamic messaging system comprising:
a question-response engine comprising machine-executable instructions stored on a memory and communicatively coupled to at least one processor, the question response engine, when executed, being configured to send at least one first customizable communication to at least one user, and the question-response engine being further configured to receive at least one response from the at least one user and send at least one second customizable communication based on information contained in the at least one response.

2. The system of claim 1 wherein the at least one response is generated by the at least one user.

3. The system of claim 1 wherein the at least one response is generated based on information contained in a profile of the at least one user.

4. The system of claim 3 wherein the profile is an electronic medical record.

5. The system of claim 2 wherein the at least one response is a text based communication.

6. The system of claim 1 wherein the at least one first customizable communication is customized utilizing information pertaining to the at least one user.

7. The system of claim 6 wherein the information is contained in an electronic medical record.

8. The system of claim 1 wherein the question-response engine contains a repository of predetermined questions and/or responses.

9. A computer implemented method embodied in a non-transitory computer-readable medium comprising computer readable instructions, which when executed by a processor, cause the processor to perform a method of dynamic messaging between at least a first location and a second location, the method comprising:
a first user configuring a question-response engine to contain at least one customizable question and at least one customizable response;
storing the at least one customizable question and the at least one customizable response in a question-response repository;
a first user sending at least one first customizable communication to at least one second user,
wherein the communication is a question, response, or statement or a combination thereof;
the second user sending at least one response to the first user; and
sending, from the first user, at least one second customizable communication based on information contained in the at least one response.

10. The method of claim 9 further comprising the step of collecting information pertaining to the at least one second user before sending the at least one customizable communication.

11. The method of claim 9 wherein the at least one second customizable communication is sent automatically.

12. The method of claim 10 wherein the information is derived from an electronic medical record.

13. The method of claim 9 further comprising the step of tagging the at least one first communication with an identifier.

14. The method of claim 13 wherein the identifier allows for filtering of responses.

15. A computer implemented method embodied in a non-transitory computer-readable medium comprising computer readable instructions, which when executed by a processor, cause the processor to perform a method of dynamic messaging between at least a first location and a second location, the method comprising the steps of:
a first user configuring a question-response engine to contain at least one customizable question and at least one customizable response;
storing the at least one customizable question and the at least one customizable response in a question-response repository;
collecting information pertaining to the at least one second user before sending the at least one customizable communication;
a first user sending at least one first customizable communication to at least one second user,
wherein the communication is a question, response, or statement or a combination thereof, and
wherein the at least one first communication is tagged with an identifier;
the second user sending at least one response to the first user; and
automatically sending, from the first user, at least one second customizable communication from the question-response engine based on information contained in the at least one response.

16. The method of claim 18 wherein the at least one response is analyzed according to the identifier associated with the at least one first communication.

17. The method of claim 18 wherein the identifier is a word or phrase associated with a subset of potential recipients of the customizable communications.
